(19) United States
(12) Patent Application Publication
(10) Pub. No.: US 2014/0316825 A1
(43) Pub. Date: Oct. 23, 2014

(54) IMAGE BASED DAMAGE RECOGNITION AND REPAIR COST ESTIMATION

(71) Applicants: Cornelis Nicolaas van Dijk, San Diego, CA (US); Robbert Nix, Zurich (CH); John Smith, JR., Escondido, CA (US)

(72) Inventors: Cornelis Nicolaas van Dijk, San Diego, CA (US); Robbert Nix, Zurich (CH); John Smith, JR., Escondido, CA (US)

(73) Assignee: AUDATEX NORTH AMERICA, INC., San Diego, CA (US)

(21) Appl. No.: 14/256,511

(22) Filed: Apr. 18, 2014

Related U.S. Application Data
(60) Provisional application No. 61/813,548, filed on Apr. 18, 2013.

(51) Int. Cl. G06Q 40/08; G06K 9/00

(52) U.S. Cl. CPC G06Q 40/08; G06K 9/00791; G06K 9/00201
USPC 705/4

(57) ABSTRACT

An apparatus and method for generating a repair cost estimate for a damaged vehicle from an image of the damaged vehicle. The image is provided to a processor that operates in accordance with instructions that perform the steps of identifying an area of the damaged vehicle that is damaged, associating at least one part with the identified damaged area, and generating a repair estimate utilizing the associated part.

### BACKGROUND OF THE INVENTION

1. Field of the Invention

The subject matter disclosed generally relates to a method and system for generating an insurance estimate for a damaged vehicle.

2. Background Information

When a vehicle such as an automobile is damaged the owner may file a claim with an insurance carrier. A claims adjuster typically inspects the vehicle to determine the amount of damage and the costs required to repair the automobile. The owner of the vehicle or the vehicle repair facility may receive a check equal to the estimated cost of the repairs. If the repair costs exceed the value of the automobile, or a percentage of the car value, the adjuster may “total” the vehicle. The owner may then receive a check equal to the value of the automobile.

The repair costs and other information may be entered by the adjuster into an estimate report. After inspection the adjuster sends the estimate report to a home office for approval. To improve the efficiency of the claims process there have been developed computer systems and accompanying software that automate the estimate process. By way of example, the assignee of the present invention, Audatex, Inc., (“Audatex”) provides a software product under the trademark Audatex Estimating that allows a claims adjuster to enter estimate data. The data includes a list of damaged parts. The parts can be selected by entering text describing the part(s) or by selection of a graphical depiction of the vehicle part(s). The Estimating product includes a database that provides the cost of the selected parts and the labor cost associated with repairing the parts. This process requires the manual entry or selection of parts data. It would be desirable to improve the efficiency of creating a repair cost estimate.

### BRIEF SUMMARY OF THE INVENTION

An apparatus and method for generating a repair cost estimate for a damaged vehicle from an image of the damaged vehicle. The image is provided to a processor that operates in accordance with instructions that perform the steps of identifying an area of the damaged vehicle that is damaged, associating at least one part with the identified damaged area, and generating a repair estimate utilizing the associated part.

### BRIEF DESCRIPTION OF THE DRAWINGS

FIG. 1 is a schematic of a network system that can be used to generate an repair cost estimate for a damaged vehicle;

FIG. 2 is a schematic of a computer of the system; and,

FIG. 3 is a flowchart showing a process for generating a repair cost estimate from an image of a damaged vehicle.

### DETAILED DESCRIPTION

Disclosed is an insurance estimating system for generating a repair cost estimate for a damaged vehicle from an image of the damaged vehicle. The image can be captured by an image device such as a camera or scanner. The image is provided to a processor that operates in accordance with instructions that perform the steps of identifying an area of the damaged vehicle that is damaged, associating at least one part with the identified damaged area, and generating a repair estimate utilizing the associate part(s).

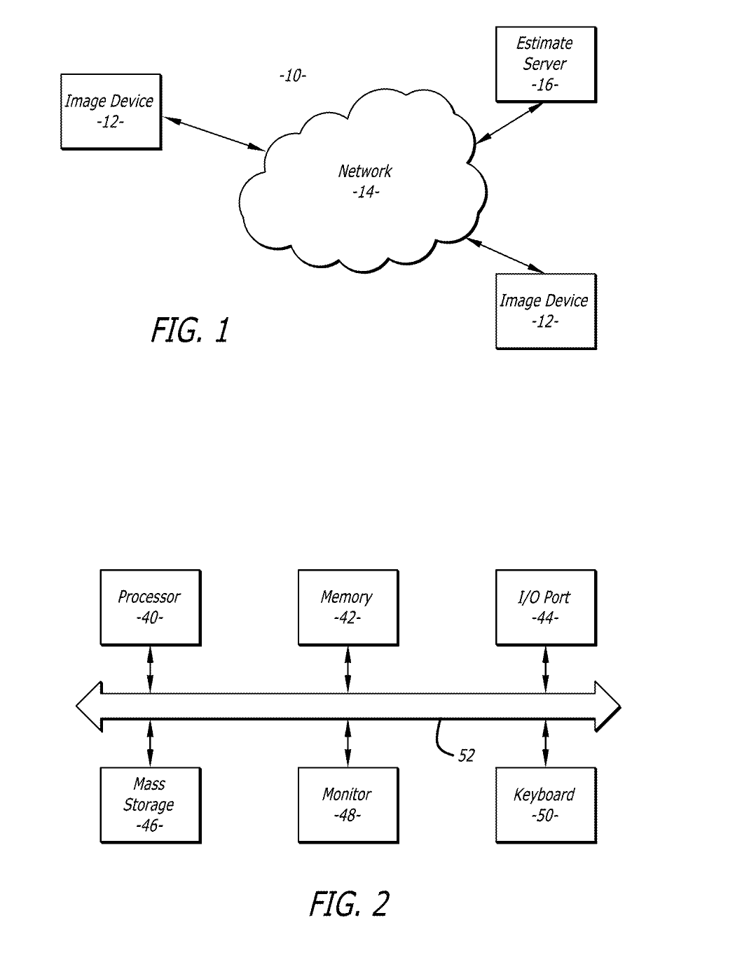

Referring to the drawings more particularly by reference numbers, FIG. 1 shows a system 10 that can be used to generate a repair cost estimate for an insurance claim of a damaged vehicle. The system 10 includes at least image device 12 that is connected to an electronic communication network 14. The electronic communication network 14 may be a wide area network (WAN) such as the Internet. Accordingly, communication may be transmitted through the network 14 in TCP/IP format. The image device 12 can capture an image of a damaged vehicle. The image may be a still image or video, captured by a device such as a camera, or mobile phone. The image device 12 may be a scanner that can be used to scan the vehicle. The images may be transmitted through the network via an intermediary device such as a personal computer.

The system 10 may further include an estimate server 16 connected to the network 14. The estimate server 16 may receive an image of a damaged vehicle from an image device 12. The estimate server 16 processes the image to generate a cost repair estimate.

FIG. 2 shows an embodiment of the server 16. The computer 12 includes a processor 40 connected to one or more memory devices 42. The memory device 42 may include both volatile and non-volatile memory such as read only memory (ROM) or random access memory (RAM). The processor 40 is capable of operating software programs in accordance with instructions and data stored within the memory device 42.

The processor 40 may be coupled to a communication port 44, a mass storage device 46, a monitor 48 and a keyboard 50 through bus 52. The processor 40 may also be coupled to a computer mouse, a touch screen, a microphone, a speaker, an optical code reader (not shown). The communication port 44 may include an ETHERNET interface that allows data to be transmitted and received in TCP/IP format, although it is to be understood that there may be other types of communication ports. The mass storage device 46 may include one or more disk drives such as magnetic or optical drives. The mass storage device 46 may also contain software that is operated by the processor 40.

Without limiting the scope of the invention the term computer readable medium may include the memory device 42 and/or the mass storage device 46. The computer readable medium may contain software programs in binary form that can be read and interpreted by the server. In addition to the memory device 42 and/or mass storage device 46, computer readable medium may also include a diskette, a compact disc, an integrated circuit, a cartridge, or even a remote communication of the software program. The server 16 may contain relational databases that correlate data with individual data fields and a relational database management system (RDBMS).

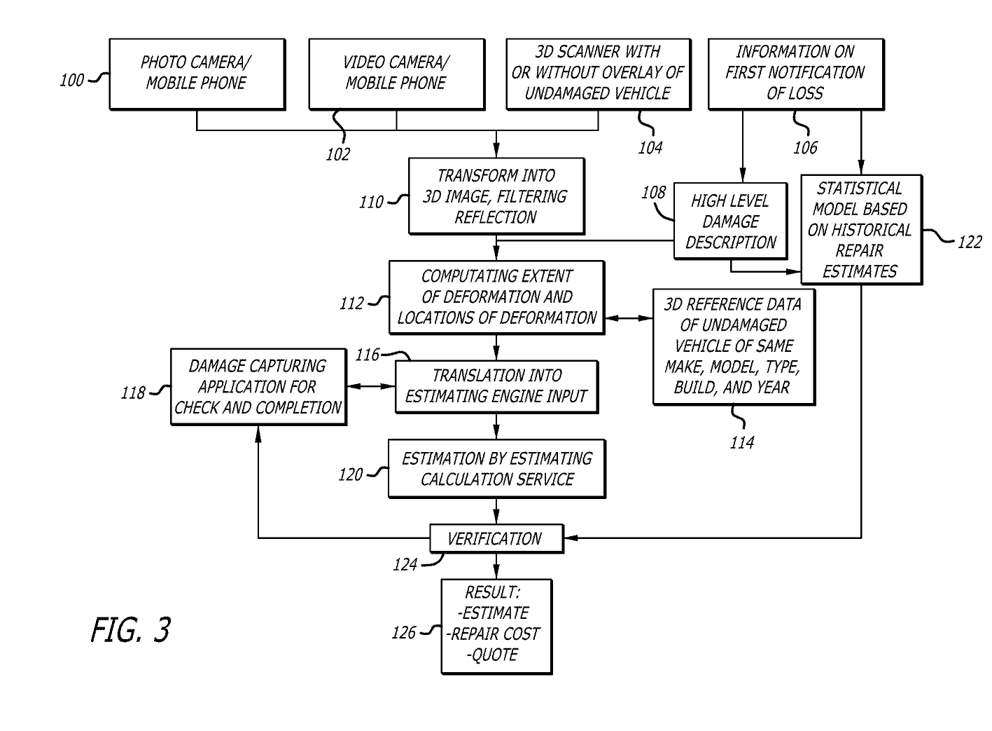

FIG. 3 is a flow chart showing a process for generating a repair cost estimate from an image of a damaged vehicle. An image of a damaged vehicle can be captured as a still image, video image or a 3D scan in blocks 100, 102 or 104, respectively. A notification of loss can be provided in block 106. In block 108 a high level description of the damage is entered by a user. This information may include policy holder information, information about the situation under which the damage occurred, cause of damage, point of impact, damage areas, road constellation, speed, and some information pertaining to the condition of the vehicle after the damage (e.g. drive-able yes/no, airbags deployed yes/no etc.). The information can include answers to a questionnaire that include:
Did the airbags go off?
Can you still drive?
Where did the accident happen (parking place, urban road, freeway, etc.)?
What happened (burglary, collision with animal/pedestrian/other car/road furniture, hail)?
Do the doors still open/close?
Which of the following parts have visible damage?
   Windows
   Lamps
   Bumpers
   Fenders
   Doors
   Rearview mirrors
   Grille
   Hood
   Tailgate
   Roof Wheels

The image of the damaged vehicle is transmitted to the estimate server. The server transforms the image into a 3D image in block 110. In block 112 deformation information is computed. The deformation information may include information on which parts of the vehicle are damaged and the extent of the damage. The deformation information may be generated by comparing the 3D image created in block 110 with a 3D image of an undamaged vehicle retrieved from a database in block 114. By way of example, optical recognition algorithms may be utilize to recognize shapes of the damaged vehicle and compare such shapes with corresponding shapes of the undamaged vehicle image. For example, a fender of the damaged vehicle can be compared to a fender of the undamaged vehicle, a door panel of the damaged vehicle can be compared to a door panel of the undamaged vehicle. The deformation computation engine identifies areas of the vehicle that are damaged.

In block 116 the deformation information is translated into input that can be interpreted by an estimating engine. By way of example, the translation engine 116 may identify the various parts associated with a damaged fender recognized by the deformation information engine 110 as being damaged. The estimating input may be presented to a user to confirm the accuracy of the deformation information in block 118. For example, the user can confirm that the parts resented as damaged are in fact damaged. A repair cost estimate is generated in block 120. The repair cost estimate engine 120 may be the same or similar to the estimating engine provided by the assignee under the product name Audatex Estimating.

In block 122 a statistical model repair estimate can be generated with the high level damage description and a statistical model based on historical repair estimate data. The statistical model engine may contain a database that correlates various description data with associated historical estimate values. The historical estimate data and various information groupings may be utilized to create curves. The curves and underlying mathematical expressions can be used to extrapolate estimate values for situations where the group of high level information does not match any defined groups in the database.

The statistical model repair estimate is compared with the repair estimate generated from the image in block 124. If the data matches within an acceptable threshold the repair cost estimate is provided to a user in block 126. If the data is not within an acceptable threshold the user may be prompted to reprocess the estimate in block 118.

The statistical model engine 122 may also calculate a probability associated with the statistical model repair estimate. The verification engine 124 may contain algorithms that utilize the probability value. For example, the verification engine 124 may ignore the statistical model repair estimate if the probability is below a threshold value. The probability value for a total loss may be generated by a binomial distribution, and the probability for an estimate may be generated by a gamma distribution, as described below.

$$Binomial distribution : \\ p is the probability that a claim is a total loss$$

$$N is the total number of cases$$

$$k is the number of cases that were a total loss$$

$$Then the binomial distribution is given by$$

$$Binomial ( N , x ; p ) = 〈 \begin{matrix}k \\ N\end{matrix} 〉 * {p}^{k} * {( 1 - p )}^{( N - k )}$$

$$likelihood defined by {\prod }_{i = 1}^{N} PDF ( {n}_{i} , {k}_{i} ; parameters )$$

$$N groups of observations with the SAME questionnaire$$

$${n}_{i} = the size of group i , \\ and {k}_{i} = number of elements in this group than were a total loss$$

$$log ( likelihood ) for Binomial distribution = {\sum }_{i}^{N} {k}_{i} * log ( {p}_{i} ) + ( {n}_{i} - {k}_{i} ) * log ( 1 - {p}_{i} ) + Constant ( from the combinations )$$

$$analyze the questionnaires , \\ and create a matrix X with first column = 1 , \\ and rest of the columns the explaining variables ( = answers to the FNOL questionnaire ) , \\ if necessary the variables are factorized . \\ define beta as the list of explaining variables . \\ replace {p}_{i} , < - 1 / ( 1 + {s}_{i} ) where {s}_{i} = exp ( {x}_{ij} {beta}_{j} )$$

$$( sum over the double indices , {x}_{ij} {beta}_{j} \text{<=>} {\sum }_{j} {x}_{ij} * {beta}_{j} )$$

$$The values {beta}_{i} are determined by maximizing the likelihood . \\ Gamma distribution \text{:}$$

$$GammaDistribution probability density function ( PDF )$$

$$GammaDistribution ( x ; alpha , theta ) = {x}^{( alpha - 1 )} * \frac{{e}^{( - x / theta )}}{{theta}^{( alpha )} * Γ ( alpha )}$$

$$where Γ ( x ) = gamma function = {\int }_{θ}^{inf} {t}^{( x - 1 )} {e}^{( - t )} d t$$

$$likelihood defined by {\prod }_{i = 1}^{N} PDF ( {x}_{i} ; parameters )$$

$$where {x}_{i} = observation nr i from N observations$$

$$log ( likelihood ) for Gamma distribution = ( alpha - 1 ) * {\sum }_{i} log ( {x}_{i} ) - {\sum }_{i} ( {x}_{i} / theta ) - N * alpha * log ( theta ) - N * log ( Γ ( alpha ) )$$

$$define {Y}_{i} = log ( {observation}_{i} )$$

$$analyze the logs of the observations , and create a matrix X with first column = 1 , and rest of the columns the explaning variables , \\ if necessary the variables are factorized . Additionally create a matrix Z with explaining variables that are modeled as additional instead of factorial . See below how theta is calculated from X and Z . \\ define beta = list of multiplicative explaining variables , \\ gamma = list of additive explaining variables for FNOL , \\ the policy information is used as multiplicative explaining parameters , and the damaged parts are used as additive explaining variables . \\ replace {x}_{i} < - {e}^{( Y )} i {theta}_{i} < - exp ( {x}_{ij} {beta}_{j} ) * ( 1 + {\sum }_{im} z * exp ( {gamma}_{m} ) )$$

$$( sum over the double indices , {x}_{ij} {beta}_{j} <= > {\sum }_{j} {x}_{ij} * {beta}_{j} ) \\ - ln L = - log ( likelihood ) = ( 1 - alpha ) * {\sum }_{i} {Y}_{i} + {\sum }_{i} i \frac{exp ( {Y}_{ij} - {X}_{j} * beta ) + alpha}{1 + Z {exp}_{im} ( {gamma}_{m} )} * {\sum }_{i} ( {x}_{ij} {beta}_{j} + log ( 1 + {z}_{im} exp ( {gamma}_{m} ) ) ) + N * log ( \vert ( alpha ) )$$

$$The values {beta}_{i} and {gamma}_{i} are determined by maximizing the likelihood .$$

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A method for generating a repair cost estimate for a damaged vehicle, comprising:
generating an image of the damaged vehicle with an image device;
providing the image to a processor that operates in accordance with instructions that perform the steps of;
identifying an area of the damaged vehicle that is damaged;
associating at least one part with the identified damaged area; and,
generating a repair estimate utilizing the associated part.

2. The method of claim 1, further comprising the steps of generating a statistical model repair estimate utilizing a statistical model based on historical repair estimate data and comparing the repair estimate with the statistical model repair estimate.

3. The method of claim 1, wherein the image of the damaged vehicle is captured with a camera.

4. The method of claim 1, wherein the image of the damaged vehicle is captured with a scanner.

5. The method of claim 1, further comprising transforming the image of the damaged vehicle into a 3D image.

6. The method of claim 1, wherein the damaged area is identified by comparing the image of the damaged vehicle with an image of an undamaged vehicle.

7. The method of claim 2, further comprising the step of calculating a probability that is associated with the statistical model repair estimate.

8. A non-transitory computer program storage medium, comprising computer-readable instructions for generating a repair cost estimate from an image of a damaged vehicle, execution of said computer-readable instructions by at least one processor to perform the steps of:
identifying an area of the damaged vehicle that is damaged;
associating at least one part with the identified damaged area; and,
generating a repair estimate utilizing the associated part.

9. The non-transitory computer program storage medium of claim 8, further comprising generating a statistical model repair estimate utilizing a statistical model based on historical repair estimate data and comparing the repair estimate with the statistical model repair estimate.

10. The non-transitory computer program storage medium of claim 8, wherein the image of the damaged vehicle is captured with a camera.

11. The non-transitory computer program storage medium of claim 8, wherein the image of the damaged vehicle is captured with a scanner.

12. The non-transitory computer program storage medium of claim 8, further comprising transforming the image of the damaged vehicle into a 3D image.

13. The non-transitory computer program storage medium of claim 8, wherein the damaged area is identified by comparing the image of the damaged vehicle with an image of an undamaged vehicle.

14. The non-transitory computer program storage medium of claim 9, further comprising the step of calculating a probability that is associated with the statistical model repair estimate.
